(19) United States
(12) Patent Application Publication
(10) Pub. No.: US 2014/0079232 A1
(43) Pub. Date: Mar. 20, 2014

(54) AUDIO PROCESSING DEVICE, AUDIO PROCESSING METHOD, AND RECORDING MEDIUM RECORDING AUDIO PROCESSING PROGRAM

(71) Applicant: Osamu Houshuyama, Tokyo (JP)

(72) Inventor: Osamu Houshuyama, Tokyo (JP)

(73) Assignee: NEC Corporation, Tokyo (JP)

(21) Appl. No.: 14/115,620

(22) PCT Filed: May 18, 2012
(86) PCT No.: PCT/JP2012/063408

§ 371 Date: Nov. 4, 2013

(30) Foreign Application Priority Data
May 19, 2011 (JP) 2011-112078

(51) Int. Cl. H04R 3/02

(52) U.S. Cl. CPC H04R 3/02
USPC 381/66

(57) ABSTRACT

The present invention provides an audio processing device that appropriately suppresses echo generated in a stereophonic audio output. The audio processing device includes: means for generating a first artificial linear echo signal and a second artificial linear echo signal that are estimated to be generated by first audio and second audio travelling to audio input means; means for suppressing a linear echo signal mixed to an input audio signal based on the first artificial linear echo signal and the second artificial linear echo signal: means for estimating a non-linear echo signal based on the first artificial linear echo signal and the second artificial linear echo signal; and means for suppressing the non-linear echo signal.

### TECHNICAL HELD

The present invention relates to a technology which suppresses an echo in audio.

### BACKGROUND ART

In the above-mentioned technical field, as shown in patent document 1, the technology to suppress the echo is known. This is the technology which generates an artificial linear echo signal from an output audio signal (far-end signal) by using an adaptive filter, suppresses a linear echo component in an input audio signal, and further, suppresses a non-linear echo component. In particular, by estimating a non-linear echo signal mixed to the input audio signal by using the artificial linear echo signal, a near-end audio signal is relatively clearly extracted from the input audio signal.

### PATENT DOCUMENT

### Patent Document 1 Republication WO 09-051197

### SUMMARY OF THE INVENTION

### Problem to be Solved by the Invention

However, an echo generated in a stereophonic audio output cannot be appropriately suppressed by the technology described in patent document 1.

The reason is because in the echo suppression device described in patent document 1, it is not assumed that two or more output audio signals (the far-end signal in patent document 1) exist to the input audio signal.

An object of the present invention is to provide a technology which solves the above-mentioned problem.

### Means For Solving a Problem

An audio processing device according to one aspect of the present invention includes

first audio output means for outputting first audio based on a first output audio signal,

second audio output means for outputting second audio based on a second output audio signal,

audio input means for inputting audio and outputting an input audio signal,

first artificial linear echo generation means for generating a first artificial linear echo signal estimated to be generated by the first audio travelling to the audio input means from the first output audio signal and outputting it,

second artificial linear echo generation means for generating a second artificial linear echo signal estimated to be generated by the second audio travelling to the audio input means from the second output audio signal and outputting it,

linear echo suppression means for generating a signal in which a linear echo signal mixed to the input audio signal is suppressed based on the outputs of the first artificial linear echo generation means and the second artificial linear echo generation means and outputting it,

non-linear echo estimation means for estimating a non-linear echo signal based on the first artificial linear echo signal and the second artificial linear echo signal, and

non-linear echo suppression means for suppressing the signal outputted by the linear echo suppression means based on the non-linear echo signal estimated by the non-linear echo estimation means.

An audio processing method according to one aspect of the present invention includes

an audio input step in which first audio and second audio that are outputted by two audio output means based on a first output audio signal and a second output audio signal are inputted by audio input means and an input audio signal is outputted,

a first artificial linear echo generation step in which a first artificial linear echo signal estimated to be generated by the first audio travelling to the audio input means is generated from the first output audio signal and outputted,

a second artificial linear echo generation step in which a second artificial linear echo signal estimated to be generated by the second audio travelling to the audio input means is generated from the second output audio signal and outputted,

a linear echo suppression step in which a signal in which a linear echo signal mixed to the input audio signal is suppressed is generated based on the first artificial linear echo signal and the second artificial linear echo signal and outputted,

a non-linear echo estimation step in which a non-linear echo signal is estimated based on the first artificial linear echo signal and the second artificial linear echo signal, and

a non-linear echo suppression step in which the signal outputted in the linear echo suppression step is suppressed based on the non-linear echo signal estimated in the non-linear echo estimation step.

A non-transitory medium according to one aspect of the present invention recording an audio processing program causing a computer to perform:

an audio input step in which first audio and second audio that are outputted by two audio output means based on a first output audio signal and a second output audio signal are inputted by audio input means and an input audio signal is outputted,

a first artificial linear echo generation step in which a first artificial linear echo signal estimated to be generated by the first audio travelling to the audio input means is generated from the first output audio signal and outputted,

a second artificial linear echo generation step in which a second artificial linear echo signal estimated to be generated by the second audio travelling to the audio input means is generated from the second output audio signal and outputted,

a linear echo suppression step in which a signal in which a linear echo signal mixed to the input audio signal is suppressed based on the first artificial linear echo signal and the second artificial linear echo signal is generated and outputted,

a non-linear echo estimation step in which a non-linear echo signal is estimated based on the first artificial linear echo signal and the second artificial linear echo signal, and

a non-linear echo suppression step in which the signal outputted in the linear echo suppression step is suppressed based on the non-linear echo signal estimated in the non-linear echo estimation step.

### Effect of the Invention

By using the present invention, the echo generated in a stereophonic audio output can be appropriately suppressed.

### BRIEF DESCRIPTION OF THE DRAWINGS

FIG. 1 is a block diagram showing a configuration of an audio processing device according to a first exemplary embodiment of the present invention.

FIG. 2 is a block diagram showing a functional configuration of an audio processing device according to a second exemplary embodiment of the present invention.

FIG. 3 is a block diagram showing a circuit configuration of the audio processing device according to a second exemplary embodiment of the present invention.

FIG. 4 is a block diagram showing a functional configuration of an audio processing device according to a third exemplary embodiment of the present invention.

FIG. 5 is a block diagram showing a circuit configuration of the audio processing device according to a third exemplary embodiment of the present invention.

FIG. 6 is a block diagram showing a configuration of an information processing device according to another exemplary embodiment of the present invention.

FIG. 7 is a figure showing a recording medium recording a program of the present invention.

### EXEMPLARY EMBODIMENTS FOR CARRYING OUT OF the INVENTION

The exemplary embodiment of the present invention will be exemplarily described in detail below with reference to the drawings. However, the components described in the following exemplary embodiment are shown as an example. Therefore, a technical scope of the present invention is not limited to those descriptions. cl First Exemplary Embodiment

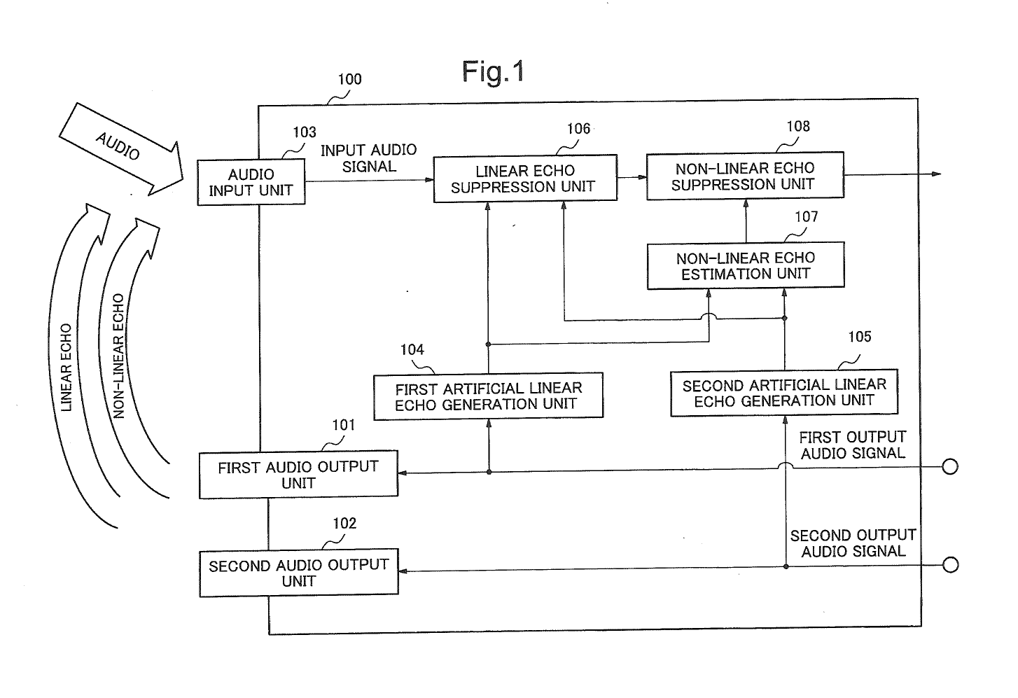

An audio processing device 100 according to a first exemplary embodiment of the present invention will be described by using FIG. 1. The audio processing device 100 is a device which suppresses a non-linear echo signal generated based on audios outputted from two audio output units.

As shown in FIG. 1, the audio processing device 100 includes a first audio output unit 101, a second audio output unit 102, and an audio input unit 103. The audio processing device 100 further includes a first artificial linear echo generation unit 104, a second artificial linear echo generation unit 105, a linear echo suppression unit 106, a non-linear echo estimation unit 107, and a non-linear echo suppression unit 108.

Among these units, the first audio output unit 101 and the second audio output unit 102 output audios that correspond to a first output audio signal and a second output audio signal, respectively.

Audio is inputted to the audio input unit 103.

The first artificial linear echo generation unit 104 generates a first artificial linear echo signal based on the first output audio signal sent to the first audio output unit 101 and outputs it.

The second artificial linear echo generation unit 105 generates a second artificial linear echo signal based on the second output audio signal sent to the second audio output unit 102 and outputs it.

The linear echo suppression unit 106 suppresses a linear echo signal mixed to an input audio signal based on the first artificial linear echo signal and the second artificial linear echo signal and outputs it.

The non-linear echo estimation unit 107 estimates the non-linear echo signal based on the first artificial linear echo signal and the second artificial linear echo signal and outputs it.

The non-linear echo suppression unit 108 suppresses the non-linear echo signal mixed to the input audio signal in which the linear echo signal is suppressed based on a result of an estimation of a non-linear echo signal and outputs it.

By using the above-mentioned configuration, the echo generated by a device having two audio input means, that is a stereophonic audio output, can be appropriately suppressed.

The reason is because the following configuration is included. First, the first artificial linear echo generation unit 104 and the second artificial linear echo generation unit 105 generate the first artificial linear echo signal and the second artificial linear echo signal based on the first output audio signal and the second output audio signal and output them, respectively. Secondly, the linear echo suppression unit 106 suppresses the linear echo signal mixed to the input audio signal based on the first artificial linear echo signal and the second artificial linear echo signal. Thirdly, the non-linear echo estimation unit 107 estimates the non-linear echo signal based on the first artificial linear echo signal and the second artificial linear echo signal and the non-linear echo suppression unit 108 suppresses the non-linear echo signal and outputs it.

### Second Exemplary Embodiment

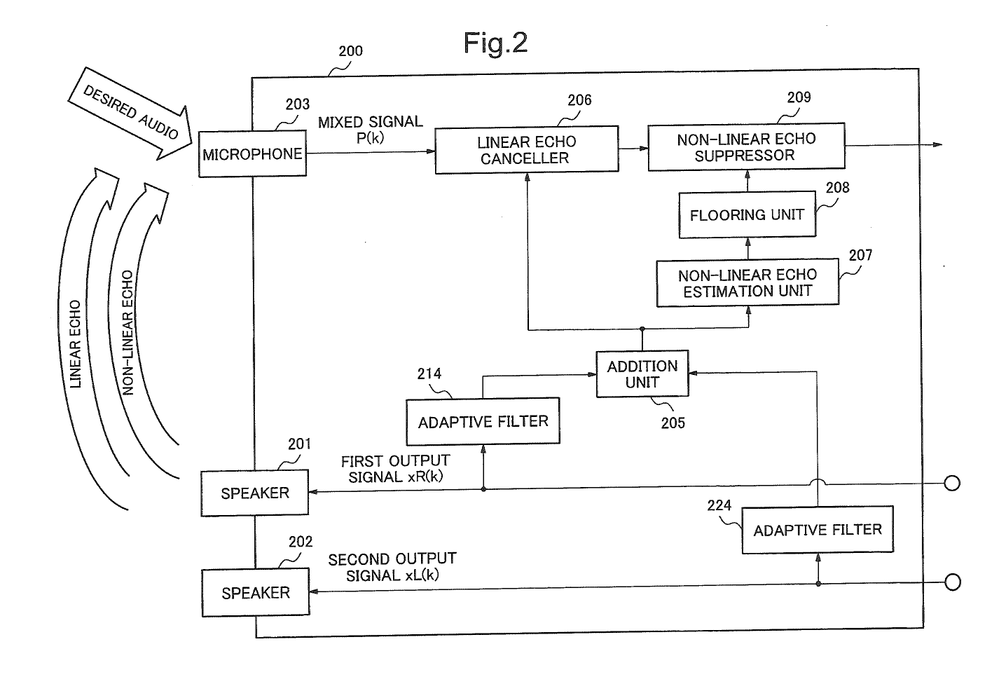

Next, an audio processing device 200 according to a second exemplary embodiment of the present invention will be described by using FIG. 2. FIG. 2 is a figure for explaining a configuration of the audio processing device 200 according to the exemplary embodiment.

As shown in FIG. 2, the audio processing device 200 includes a microphone 203 as the audio input unit and speakers 201 and 202 as the first and second audio output units. The speakers 201 and 202 output the audios according to a first output signal xR(k) and a second output signal xL(k), respectively. For example, the first output signal xR(k) and the second output signal xL(k) are stereophonic audio signals. In this case, the speakers 201 and 202 output the stereophonic audios.

Further, the audio processing device 200 includes an adaptive filter 214, an adaptive filter 224, and an addition unit 205. The adaptive filters 214 and 224 input the first output signal xR(k) and the second output signal xL(k), generate artificial linear echo signals, and output them, respectively. The addition unit 205 adds the artificial linear echo signals that are outputted by the adaptive filter 214 and the adaptive filter 224, respectively and outputs it as a combined artificial linear echo signal.

Further, the audio processing device 200 includes a linear echo canceller 206, a non-linear echo estimation unit 207, a flooring unit 208, and a non-linear echo suppressor 209. The combined artificial linear echo signal generated by the addition unit 205 is supplied to both of the linear echo canceller 206 and the non-linear echo estimation unit 207.

The linear echo canceller 206 subtracts the artificial linear echo signal combined by the addition unit 205 from a mixed signal P(k) and output it. On the other hand, the non-linear echo estimation unit 207 estimates a non-linear echo signal based on the artificial linear echo signal combined by the addition unit 205. The flooring unit 208 applies a flooring process to the non-linear echo signal estimated by the non-linear echo estimation unit 207 and outputs a flooring result. The non-linear echo suppressor 209 suppresses the non-linear echo signal in the output signal of the linear echo canceller 206 by gain control based on the flooring result and outputs it.

The above-mentioned configuration is conceived based on a new idea in which the influence of echoes caused by two speakers are regarded as the influence of a linear echo caused by one speaker and are suppressed. And, the echoes caused by two speakers can be suppressed by using a very simple configuration.

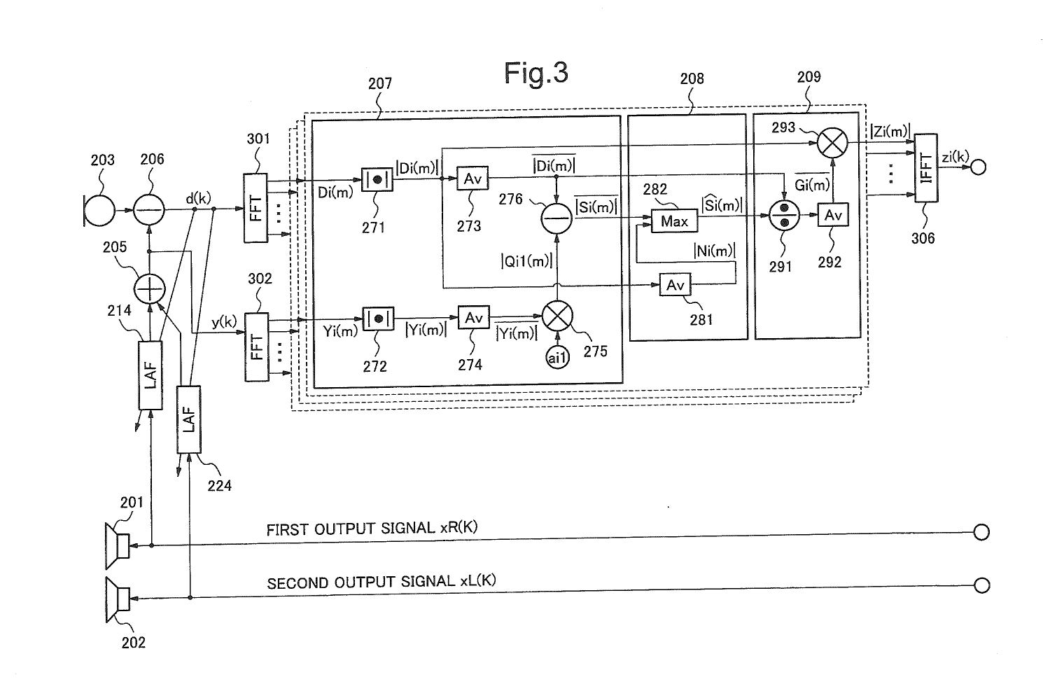

Next, the circuit configuration of the audio processing device 200 will be explained by using FIG. 3. FIG. 3 is a figure showing a further concrete circuit configuration of the audio processing device 200.

As explained by using FIG. 2, the first output signal xR(k) and the second output signal xL(k) are inputted to the adaptive filter 214 and the adaptive filter 224 and the adaptive filter 214 and the adaptive filter 224 generate the artificial linear echo signals, respectively. The explanation of the adaptive filter is described in detail in U.S. Patent Application Publication No. 2010-0260352 A1. Therefore, the detailed description about the adaptive filter will be omitted here.

The addition unit 205 adds the generated artificial linear echo signals and generates the combined artificial linear echo signal.

A subtractor subtracts the combined artificial linear echo signal from the input audio signal outputted by the microphone 203 as the linear echo canceller 206, generates a residual signal d(k), and outputs it.

The residual signal d(k) is inputted to a fast Fourier transform (FFT) unit 301 and a combined artificial linear echo signal y(k) is inputted to a fast Fourier transform unit 302.

The audio processing device 200 further includes the fast Fourier transform unit 301, the fast Fourier transform unit 302, the non-linear echo estimation unit 207, the flooring unit 208, the non-linear echo suppressor 209, and an inverse fast Fourier transform (IFFT) unit 306.

The fast Fourier transform units 301 and 302 convert the residual signal d(k) and the artificial linear echo signal y(k) into frequency spectrums, respectively.

The non-linear echo estimation unit 207, the flooring unit 208, and the non-linear echo suppressor 209 are provided for each frequency component.

The inverse fast Fourier transform unit 306 integrates an amplitude spectrum derived for each frequency component and a corresponding phase, performs an inverse fast Fourier transform and performs recombination to form an output signal zi(k) in a time domain. Further, namely, the output signal zi(k) in the time domain is a signal having an audio waveform sent to a communication partner.

Although the waveform of the linear echo signal is completely different from that of the non-linear echo signal, with respect to the spectral amplitude for each frequency, there is a correlation between the amplitudes of the both signals. Namely, when the amplitude of the artificial linear echo signal is large, the amplitude of the non-linear echo signal is large. In other words, an amount of the non-linear echo signal can be estimated based on the artificial linear echo signal.

Accordingly, the non-linear echo estimation unit 207 estimates the spectral amplitude of the desired audio signal based on the estimated amount of the non-linear echo signal. Although the estimated spectral amplitude of the audio signal has an error, the flooring unit 208 performs a flooring process so as not to cause an uncomfortable feeling subjectively by the estimation error.

For example, when the estimated spectral amplitude of the audio signal is excessively small and smaller than the spectral amplitude of a background noise, the signal level varies according to the presence or absence of an echo and a feeling of strangeness is brought. As a countermeasure against this, the flooring unit 208 estimates the level of the background noise and uses it as a lower limit of the estimated spectral amplitude to reduce the level variation.

On the other hand, when the large residual echo remains in the estimated spectral amplitude by the estimation error, the residual echo intermittently and rapidly changes to an artificial additional sound called musical noise. As a countermeasure against this, in order to eliminate the echo, the non-linear echo suppressor 209 does not perform a subtraction of the estimated non-linear echo signal and functions as a spectral gain calculation unit which performs a multiplication of a gain so as to obtain the amplitude that is approximately equal to the amplitude obtained by the subtraction. By performing a smoothing process to prevent a sudden gain change, an intermittent change of the residual echo can be suppressed.

Hereinafter, the internal configuration of the non-linear echo estimation unit 207, the flooring unit 208, and the non-linear echo suppressor 209 will be described by using a mathematical expression.

The residual signal d(k) inputted to the fast Fourier transform unit 301 is a sum of a near-end signal s(k) and a residual non-linear echo signal q(k).

d(k)=s(k)+q(k) (1)

It is assumed that the linear echo is almost completely eliminated by the adaptive filter 214, the adaptive filter 224, and the subtractor (the linear echo canceller 206). Only a non-linear component is considered in a frequency domain. By the fast Fourier transform units 301 and 302, equation (1) is converted into the following equation in frequency domain.

D(m)=S(m)+Q(m) (2)

Here, m is a frame number and the vectors D(m), S(m), and Q(m) are expressions of which d(k), s(k), and q(k) are converted into a frequency domain, respectively. It is assumed that each frequency is independent. By transforming equation (2), it is expressed as follows at the i-th frequency.

Si(m)=Di(m)−Qi(m) (3)

Because the adaptive filter 214, the adaptive filter 224, and the subtractor (the linear echo canceller 206) remove the correlation, there is hardly a correlation between Di(m) and Yi(m). Accordingly, the subtractor 276 performs a calculation of |̅S̅i̅( [symbol] ²) as follows.

$$\overline{\vert Si ( \text{?}} = \overline{\vert Di ( \text{?}} - \overline{\vert Qi ( \text{?}}$$

$$\text{?} \text{indicates text missing or illegible when filed}$$

|̅D̅i̅( [symbol] ²) is derived from Di(m) by using an absolute value obtaining circuit 271 and an averaging circuit 273.

On the other hand, the non-linear echo signal |Qi(m)| can be modeled as a product of a regression coefficient ai and an average echo replica |̅Y̅i̅( [symbol] as follows.

$$\vert Qi ( \text{?} a \overline{i \vert Yi ( \text{?}} \\ \text{?} \text{indicates text missing or illegible when filed}$$

Accordingly, the absolute value obtaining circuit 272 and the averaging circuit 274 derive the average echo replica |̅Y̅i̅( [symbol] from Yi(m) and an integration unit 275 multiplies it by the regression coefficient ai. Here, the regression coefficient ai is a regression coefficient indicating a correlation between |Qi(m)| and |Yi(m)|. This model is based on an experimental result showing that there is a significant correlation between |Qi(m)| and |Yi(m)|.

Equation (3) is an additive model that is widely used for a noise suppression. In the spectral shaping shown in FIG. 3, in the noise suppression, a spectral multiplication type configuration in which an uncomfortable musical noise is hardly generated is used. By using a spectral multiplication, an amplitude |Zi(m)| of the output signal is obtained as the product of the spectral gain Gi(m) and the residual signal |Di(m)|.

$$\vert Zi ( \text{?} = \overline{Gi (} {m}^{*} ) \vert Di ( \text{?} ) \\ \text{?} \text{indicates text missing or illegible when filed}$$

A square root of equation (6) is taken, a mean square of equation (3) is taken, and ai²*|Yi(m)|² is substituted for |Qi(m)|² in equation (4). By performing this process, the estimation value |̅S̅i̅( [symbol] ) of |Si(m)| may be obtained as follows. By performing this method, the non-linear echo signal can be further effectively suppressed.

$$\overline{\vert Si ( \text{?}} \sqrt{\overline{\vert Di ( \text{?}} - \overline{{a}^{2} i \cdot \vert Yi ( \text{?}}}$$

$$\text{?} \text{indicates text missing or illegible when filed}$$

Because the model is not elaborate, the estimated amplitude |̅S̅i̅( [symbol] ) has a non-negligible error. When the error is large and an over-subtraction occurs, a high-frequency component of the near-end signal decreases or a feeling of modulation occurs. In particular, when the near-end signal is constantly generated like a sound of an air conditioner, the feeling of modulation is uncomfortable. In order to reduce the feeling of modulation subjectively, the flooring on a spectrum is used by the flooring unit 208.

First, in the flooring unit 208, the averaging circuit 281 estimates a stationary component |Ni(m)| of the near-end signal Di(m). Next, a maximum value selection circuit 282 uses the stationary component |Ni(m)| as a lower limit and performs the flooring. As a result, an amplitude estimation value |Ŝi( [symbol] ) of the near-end signal that is better estimated can be obtained. After that, a divider 291 calculates a ratio of |Ŝi to ( [symbol] ) to |̅D̅i̅( [symbol] ). Further, an averaging circuit 292 performs an averaging of this ratio and obtains the spectral gain G̅i̅(m.

Finally, as shown in mathematical expression (5), an integrator 293 calculates the product of the spectral gain Gi(m) and the residual signal |Di(m)|. By performing this process, the amplitude |Zi(m)| can be obtained as the output signal. The inverse fast Fourier transform unit 306 performs an inverse Fourier transform of the amplitude |Zi(m)| and outputs the audio signal zi(k) in which the non-linear echo is effectively suppressed.

The regression coefficient ai can be estimated from the input to the microphone 203 when an audio is outputted from the speaker. As disclosed in republication 2009/051197, the regression coefficient may be updated according to the status.

By using the above-mentioned configuration, the linear echo signal and the non-linear echo signal caused by two speakers 201 and 202 can be effectively suppressed.

The reason is because the echo is suppressed by the linear echo canceller 206, the fast Fourier transform unit 301, the fast Fourier transform unit 302, the non-linear echo estimation unit 207, the flooring unit 208, the non-linear echo suppressor 209, and the inverse fast Fourier transform unit 306 based on the combined artificial linear echo signal obtained by combining the outputs of the adaptive filter 214 and the adaptive filter 224.

Further, when the above-mentioned configuration is used, a circuit design can be efficiently performed. p The reason is because with respect to the first output signal xR(k) and the second output signal xL(k) sent to two speakers, the linear echo canceller 206, the fast Fourier transform unit 301, the fast Fourier transform unit 302, the non-linear echo estimation unit 207, the flooring unit 208, the non-linear echo suppressor 209, and the inverse fast Fourier transform unit 306 are shared.

### Third Exemplary Embodiment

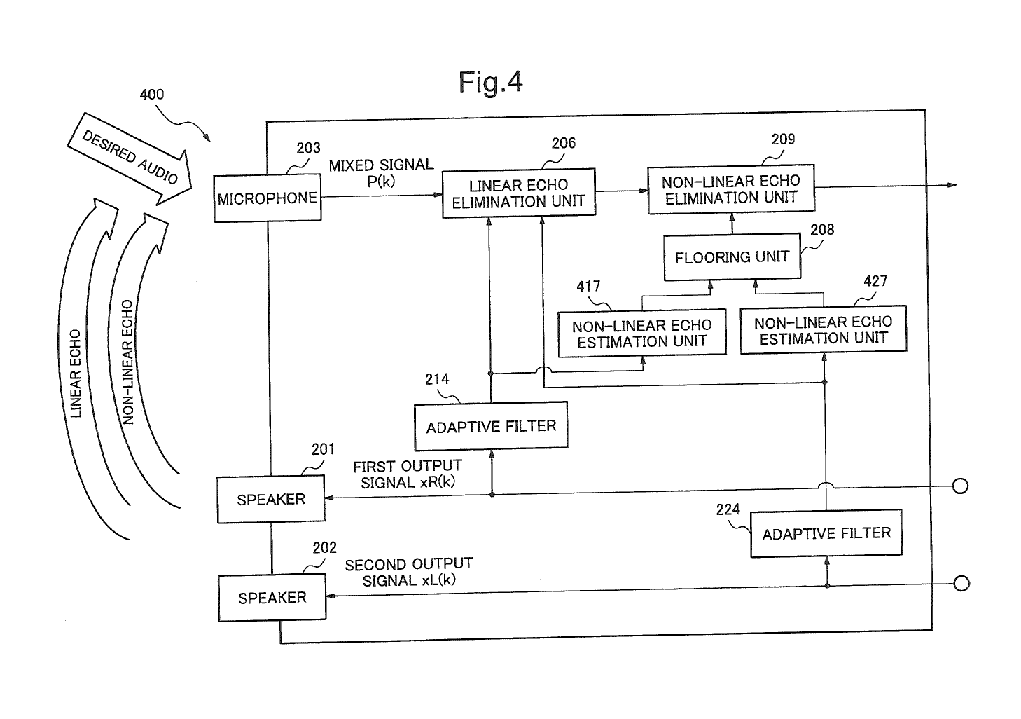

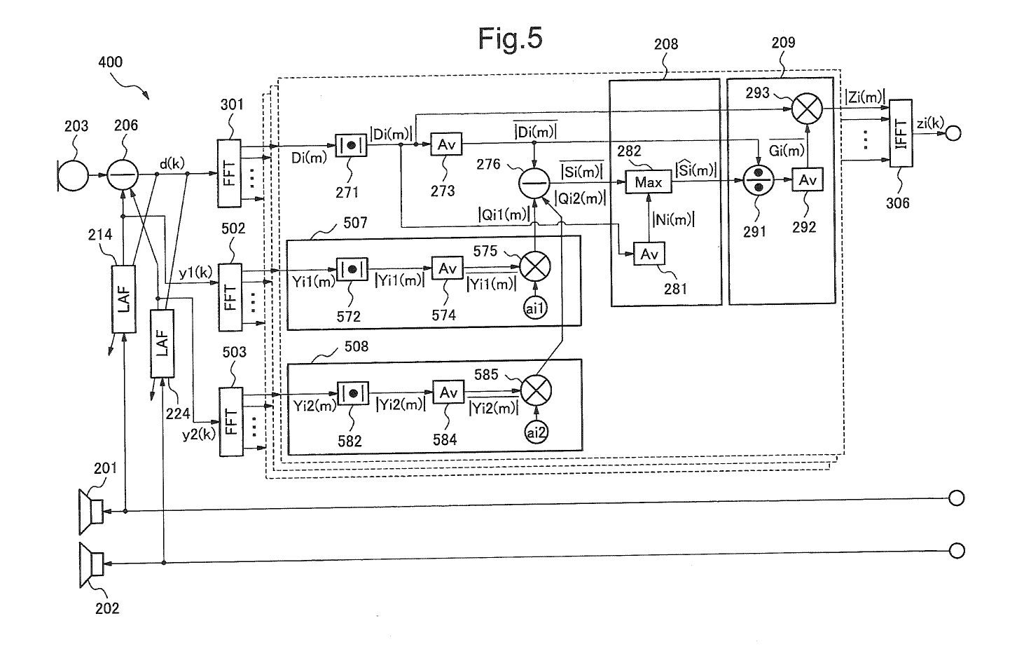

Next, an audio processing device 400 according to a third exemplary embodiment of the present invention will be described by using FIG. 4 and FIG. 5. FIG. 4 is a figure for explaining a functional configuration of the audio processing device 400 according to the exemplary embodiment.

As compared with the audio processing device 200 according to the second exemplary embodiment, the audio processing device 400 according to the third exemplary embodiment is different in the respect that it does not include the non-linear echo estimation unit 207 but includes a non-linear echo estimation unit 417 and a non-linear echo estimation unit 427.

The non-linear echo estimation unit 417 functions as first non-linear echo estimation means that estimate a first non-linear echo signal from the first artificial linear echo signal and the non-linear echo estimation unit 427 functions as second non-linear echo estimation means that estimate a second non-linear echo signal from the second artificial linear echo signal. The configuration and the operation of the audio processing device 400 according to the third exemplary embodiment are the same as those of the audio processing device 200 according to the second exemplary embodiment excluding the above-mentioned points.

Therefore, the same reference numbers are used for the components having the same configuration and operation as the second exemplary embodiment and the detailed explanation of these components is omitted.

FIG. 5 is a figure showing a circuit configuration of the audio processing device 400.

The audio processing device 400 includes the fast Fourier transform unit 301, a fast Fourier transform unit 502, and a fast Fourier transform unit 503. Further, the audio processing device 400 includes a non-linear echo estimation unit 507, a non-linear echo estimation unit 508, the flooring unit 208, the non-linear echo suppressor 209, and the inverse fast Fourier transform unit 306.

The fast Fourier transform unit 301 converts the residual signal d(k) into a frequency spectrum Di(m). The fast Fourier transform unit 502 and the fast Fourier transform unit 503 convert two artificial linear echo signals y1(k) and y2(k) into frequency spectrums Yi1 (m) and Yi2(m), respectively.

The non-linear echo estimation unit 507, the non-linear echo estimation unit 508, the flooring unit 208, and the non-linear echo suppressor 209 are provided for each frequency component.

The inverse fast Fourier transform unit 306 integrates an amplitude spectrum derived for each frequency component and a corresponding phase, performs an inverse fast Fourier transform, and performs recomposition of the output signal zi(k) in time domain. Further, namely, the output signal zi(k) in time domain is a signal having an audio waveform that is sent to a communication partner.

The non-linear echo estimation units 507 and 508 estimate a spectral amplitude of a desired audio signal based on an estimated amount of a non-linear echo signal.

Because the adaptive filter 214, the adaptive filter 224, and the subtractor (the linear echo canceller 206) remove the correlation, there is hardly a correlation between Di(m) and Yi(m). Accordingly, |̅S̅i̅( [symbol] ²) can be obtained by the subtractor 276 as follows.

$$\overline{\vert Si ( \text{?}} = \overline{\vert Di ( \text{?}} - {( \overline{\vert Q i 1 ( m \vert )} )}^{2} - {( \overline{\vert Q i 2 ( m \vert \vert} )}^{2}$$

$$\text{?} \text{indicates text missing or illegible when filed}$$

The non-linear echo signals |Qi1(m)| and |Qi2(m)| can be modeled as a product of one of the regression coefficients ai1 and as2 and one of the average echo replicas |̅Y̅i̅1̅( [symbol] and |̅Y̅i̅2̅( [symbol] as follows.

$$\vert Qi ( \text{?} a i \overline{1 \vert \cdot Y i 1 ( \text{?} )} \\ \text{?} \text{indicates text missing or illegible when filed}$$

$$\vert Q i ( \text{?} a i \overline{2 \vert \cdot Y i 2 ( \text{?} )} \\ \text{?} \text{indicates text missing or illegible when filed}$$

Accordingly, an absolute value obtaining circuit 572 and an averaging circuit 574 derive the average echo replica |̅Y̅i̅1̅( [symbol] from Yi1(m) and an integration unit 575 performs multiplication of the regression coefficient ai1. Further, an absolute value obtaining circuit 582 and an averaging circuit 584 derive the average echo replica |̅Y̅i̅2̅( [symbol] from Yi2m) and an integration unit 585 performs multiplication of the regression coefficient ai2.

On the other hand, the estimation value |̅S̅i̅( [symbol] ) of |Si(m)| may be obtained as follows. By performing this process, the non-linear echo signal can be further effectively suppressed.

In order to reduce the feeling of modulation subjectively, the flooring on the spectrum is performed by the flooring unit 208. The integrator 293 calculates the product of the spectral gain Gi(m) and the residual signal |Di(m)| and outputs the amplitude |Zi(m)| as the output signal. The inverse fast Fourier transform unit 306 performs an inverse Fourier transform of the amplitude |Zi(m)| and outputs the audio signal zi(k) in which the non-linear echo is effectively suppressed.

The regression coefficients ai1 and ai2 can be individually estimated from the input of the microphone 203 when the audio is individually outputted from one of the speakers 201 and 202. As disclosed in republication 2009/051197, the regression coefficient may be updated according to the status.

By using the above-mentioned configuration, the third exemplary embodiment can obtain the effect that is the same as that of the second exemplary embodiment.

The reason is because the non-linear echo estimation unit 417 and the non-linear echo estimation unit 427 are included instead of the non-linear echo estimation unit 207.

### Another Exemplary Embodiment

The exemplary embodiment of the present invention has been described in detail above. However, a system or a device in which the different features included in the respective exemplary embodiments are arbitrarily combined is also included in the scope of the present invention.

Further, the present invention may be applied to a system composed of a plurality of devices and it may be applied to a stand-alone device. Furthermore, the present invention can be applied to a case in which an information processing program which realizes the function of the exemplary embodiment is directly or remotely supplied to the system or the device.

Accordingly, a program installed in a computer to realize the function of the present invention by the computer, a medium storing the program, and a WWW (World Wide Web) server which downloads the program are also included in the scope of the present invention.

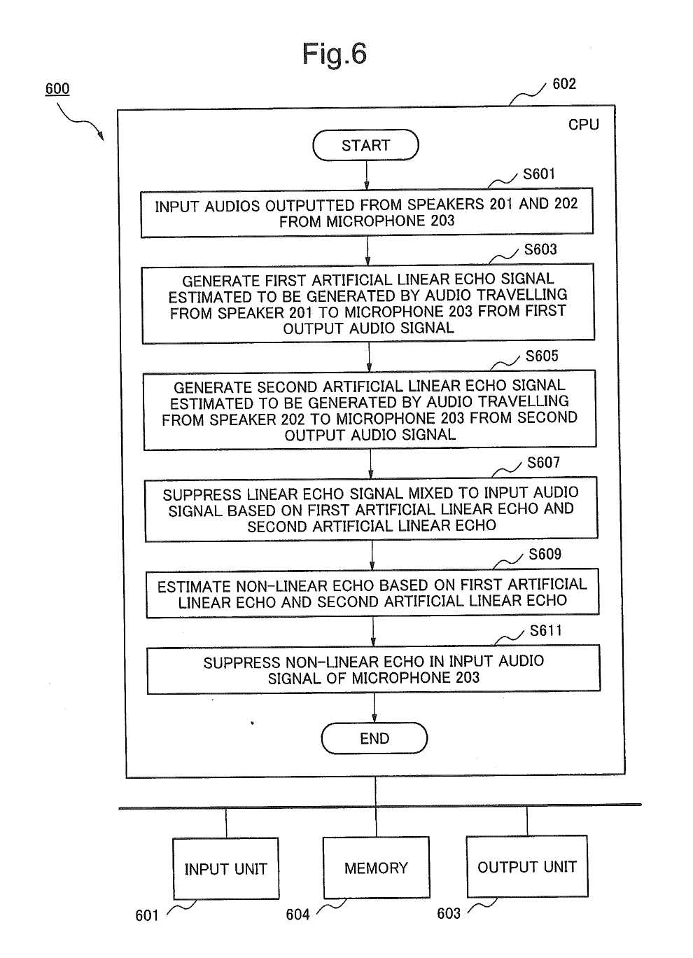

Hereinafter, as an example, in a case in which the audio process described in the second exemplary embodiment is realized by software, a flow of this process executed by a CPU (Central Processing Unit) 602 provided in a computer 600 will be described by using FIG. 6.

First, the CPU 602 inputs a first audio and a second audio outputted from two speakers 201 and 202 from the microphone 203 based on a first output audio signal and a second output audio signal and outputs a input audio signal (S601).

The CPU 602 generates a first artificial linear echo signal estimated to be generated by an audio travelling from the speaker 201 to the microphone 203 from the first output audio signal (S603).

The CPU 602 generates a second artificial linear echo signal estimated to be generated by an audio travelling from the speaker 202 to the microphone 203 from the second output audio signal (S605).

The CPU 602 suppresses a linear echo signal mixed to the input audio signal based on the first artificial linear echo signal and the second artificial linear echo signal (S607).

The CPU 602 estimates the non-linear echo signal based on the first artificial linear echo signal and the second artificial linear echo signal (S609). The CPU 602 suppresses the estimated non-linear echo signal (S611).

By performing the above mentioned processes, this exemplary embodiment can obtain the effect that is the same as that of the second exemplary embodiment.

Further, an input unit 601 may include the audio input unit 103 and the microphone 203. An output unit 603 may include the first audio output unit 101, the second audio output unit 102, the speaker 201, and the speaker 202. A memory 604 stores information. When the CPU 602 performs the operation of each step, the CPU 602 writes the required information into the memory 604 and reads out the required information from the memory 604.

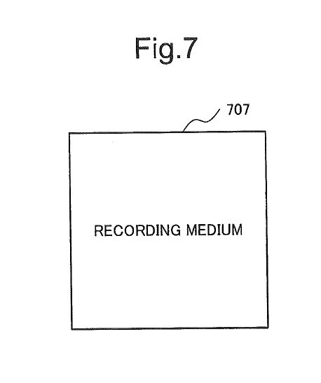

FIG. 7 is a figure showing an example of a recording medium (storage medium) 707 which records (stores) the program. The recording medium 707 is a non-transitory recording medium that is a non-temporary storage medium for storing information. Further, the recording medium 707 may be a recording medium that is a temporary storage medium for storing information. The recording medium 707 records the program (software) which causes the computer 600 (CPU 602) to perform the operation shown in FIG. 6. Further, the recording medium 707 may record an arbitrary program and data.

The recording medium 707, which records a code of the above-mentioned program(software), may be supplied to the computer 600, and CPU 602 may read and carry out the code of the program which is stored in the recording medium 707. Or, CPU 602 may make the code of the program, which is stored in the recording medium 707, stored in the memory 604. That is, the exemplary embodiment includes an exemplary embodiment of the recording medium 707 recording the program, which is executed by the computer 600 (CPU 602), temporarily or non-temporarily.

While the present invention has been described with reference to the exemplary embodiment, the present invention is not limited to the above-mentioned exemplary embodiment. Various changes, which a person skilled in the art can understand, can be added to the composition and the details of the invention of the present application in the scope of the invention of the present application.

This application claims priority from Japanese Patent Application No. 2011-112078 filed on May 19, 2011, the disclosure of which is hereby incorporated by reference in its entirety.

### DESCRIPTION OF THE REFERENCE NUMERALS

100 audio processing device

101 first audio output unit

102 second audio output unit

103 audio input unit

104 first artificial linear echo generation unit

105 second artificial linear echo generation unit

106 linear echo suppression unit

107 non-linear echo estimation unit

108 non-linear echo suppression unit

200 audio processing device

201 speaker

202 speaker

203 microphone

205 addition unit

206 linear echo canceller

207 non-linear echo estimation unit

208 flooring unit

209 non-linear echo suppressor

214 adaptive filter

224 adaptive filter

271 absolute value obtaining circuit

272 absolute value obtaining circuit

273 averaging circuit

274 averaging circuit

275 integration unit

276 subtractor

281 averaging circuit

282 maximum value selection circuit

291 divider

292 averaging circuit

293 integrator

301 fast Fourier transform unit

302 fast Fourier transform unit

306 inverse fast Fourier transform unit

400 audio processing device

417 non-linear echo estimation unit

427 non-linear echo estimation unit

502 fast Fourier transform unit

503 fast Fourier transform unit

507 non-linear echo estimation unit

508 non-linear echo estimation unit

572 absolute value obtaining circuit

574 averaging circuit

575 integration unit

582 absolute value obtaining circuit

584 averaging circuit

585 integration unit

600 computer

602 CPU

707 recording medium

1. An audio processing device, comprising:
first audio output means for outputting first audio based on a first output audio signal,
second audio output means for outputting second audio based on a second output audio signal,
audio input means for inputting audio and outputting an input audio signal,
first artificial linear echo generation means for generating a first artificial linear echo signal estimated to be generated by the first audio travelling to the audio input means from the first output audio signal and outputting it,
second artificial linear echo generation means for generating a second artificial linear echo signal estimated to be generated by the second audio travelling to the audio input means from the second output audio signal and outputting it,
linear echo suppression means for generating a signal in which a linear echo signal mixed to the input audio signal is suppressed based on the outputs of the first artificial linear echo generation means and the second artificial linear echo generation means and outputting it,
non-linear echo estimation means for estimating a non-linear echo signal based on the first artificial linear echo signal and the second artificial linear echo signal, and
non-linear echo suppression means for suppressing the signal outputted by the linear echo suppression means based on the non-linear echo signal estimated by the non-linear echo estimation means.

2. The audio processing device according to claim 1, further comprising addition means for adding the first artificial linear echo signal and the second artificial linear echo signal.

3. The audio processing device according to claim 2,
wherein an addition result obtained by the addition means is inputted to the linear echo suppression means and the non-linear echo estimation means.

4. The audio processing device according to any one of claims 1 to 3, further comprising flooring means for performing a flooring process to an estimation result obtained by the non-linear echo estimation means.

5. The audio processing device according to any one of claims 1 to 4,
wherein the non-linear echo suppression means suppress the non-linear echo signal based on a flooring result obtained by the flooring means.

6. The audio processing device according to any one of claims 1 to 5,
wherein the non-linear echo estimation means include:
first non-linear echo estimation means for estimating a first non-linear echo signal from the first artificial linear echo signal and
second non-linear echo estimation means for estimating a second non-linear echo signal from the second artificial linear echo signal.

7. An audio processing method comprising:
an audio input step in which first audio and second audio that are outputted by two audio output means based on a first output audio signal and a second output audio signal are inputted by audio input means and an input audio signal is outputted,
a first artificial linear echo generation step in which a first artificial linear echo signal estimated to be generated by the first audio travelling to the audio input means is generated from the first output audio signal and outputted,
a second artificial linear echo generation step in which a second artificial linear echo signal estimated to be generated by the second audio travelling to the audio input means is generated from the second output audio signal and outputted,
a linear echo suppression step in which a signal in which a linear echo signal mixed to the input audio signal is suppressed is generated based on the first artificial linear echo signal and the second artificial linear echo signal and outputted,
a non-linear echo estimation step in which a non-linear echo signal is estimated based on the first artificial linear echo signal and the second artificial linear echo signal, and
a non-linear echo suppression step in which the signal outputted in the linear echo suppression step is suppressed based on the non-linear echo signal estimated in the non-linear echo estimation step.

8. A non-transitory medium recording an audio processing program causing a computer to perform:
an audio input step in which first audio and second audio that are outputted by two audio output means based on a first output audio signal and a second output audio signal are inputted by audio input means and an input audio signal is outputted,
a first artificial linear echo generation step in which a first artificial linear echo signal estimated to be generated by the first audio travelling to the audio input means is generated from the first output audio signal and outputted,
a second artificial linear echo generation step in which a second artificial linear echo signal estimated to be generated by the second audio travelling to the audio input means is generated from the second output audio signal and outputted,
a linear echo suppression step in which a signal in which a linear echo signal mixed to the input audio signal is suppressed based on the first artificial linear echo signal and the second artificial linear echo signal is generated and outputted,
a non-linear echo estimation step in which a non-linear echo signal is estimated based on the first artificial linear echo signal and the second artificial linear echo signal, and
a non-linear echo suppression step in which the signal outputted in the linear echo suppression step is suppressed based on the non-linear echo signal estimated in the non-linear echo estimation step.
